(19) United States
(12) Patent Application Publication
(10) Pub. No.: US 2008/0172494 A1
(43) Pub. Date: Jul. 17, 2008

(54) METHOD AND APPARATUS FOR DETERMINING COMMUNICATION PROTOCOL

(75) Inventors: Yeo-jin KIM, Suwon-si (KR); Kyung-im JUNG, Seongnam-si (KR); Ji-soo KIM, Yongin-si (KR); Yun-sang OH, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/840,517

(22) Filed: Aug. 17, 2007

(30) Foreign Application Priority Data
Jan. 12, 2007 (KR) 10-2007-0003936

(51) Int. Cl. G06F 15/16

(52) U.S. Cl. 709/230

(57) ABSTRACT

A method and apparatus for determining a communication protocol are provided. The apparatus for determining a communication protocol includes a protocol recording unit which records one or more applicable communication protocols, and a protocol parsing unit which parses a common communication protocol determined by another apparatus among the recorded communication protocols and provides the common communication protocol so as to communicate with the another apparatus.

### CROSS REFERENCE TO RELATED APPLICATION

This application claims priority from Korean Patent Application No. 10-2007-0003936, filed on Jan. 12, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to determining a communication protocol, and more particularly, to determining a communication protocol that is capable of recognizing a communication protocol of a counterpart apparatus between multimedia cards for security where resources are restricted and a host apparatus, determining a communication protocol to be used, and reducing a time delay and unnecessary parsing which may occur while the communication protocol is determined.

2. Description of the Related Art

Generally, a multimedia card for security (hereinafter, referred to as a security card) serves to safely store and use private data or security data, such as Digital Rights Management (DRM) information, and a host apparatus (hereinafter, referred to as a host) uses data that is stored in the security card.

For reference, different communication protocols can be used according to types of the hosts, and the security card can apply two or more protocols such that the hosts can use existing communication protocols.

FIG. 1 is a block diagram illustrating a structure of a host and a security card according to a related art.

An apparatus illustrated in FIG. 1 includes interfaces 114 and 124 that are connection portions between a host 110 and a security card 120 and enable a communication through a physical contact or non-contact apparatus, applications 113 and 123 that serve as programs through which the host exchanges information with the security card and processes a communication protocol negotiation, file systems 112 and 122, each of which accesses a storage region of each apparatus and manages the storage region such that a file or a directory can be written or read in the storage region, and storage regions 111 and 121, each of which is a physical region for storing data in each apparatus and accesses the file system.

Generally, the host applies two or more communication protocols according to a type of security card. At this time, when it is assumed that N protocols from a first protocol to an N-th protocol exist as communication protocols applicable by the host, a method in which the host and the security card negotiate a communication protocol is as a flowchart illustrated in FIG. 2.

FIG. 2 is a flowchart illustrating a communication method of the host and the security card illustrated in FIG. 1.

The host 110 transmits a communication start message to the security card 120 using a first protocol among protocols applicable by the host (S201).

After Operation S201, if the security card 120 cannot parse a message that is received from the host 110, the security card 120 does not apply the corresponding protocol, and ignores the message (S202).

After Operation S202, the host 110 waits for a response of the security card 120 for a predetermined time, and when there is no response from the security card 120, the host 110 transmits a next protocol to the security card 120 (S203).

For reference, the host 110 and the security card 120 can repeat Operations S202 and 203.

After Operation S203, if the security card 120 can parse a message that is received from the host 110, the security card 120 transmits a valid response message to the host 110 using a corresponding protocol (S204).

After Operation S204, the host 110 and the security card 120 communicate with each other using the corresponding protocol (S205).

If there is no protocol that is commonly applied by the host 110 and the security card 120, the communication between the host 110 and the security card 120 is not made. In the above-described method of negotiating a communication protocol according to the related art, in order to find a protocol that is commonly applicable by the security card 120 and the host 110, a try is sequentially given to protocols that are applicable by the host 110.

According to this related art method, when the security card does not apply the protocols until a try is given by the host, a predetermined time delay is generated, and unnecessary parsing is repeated for messages of the communication protocols that are not applied by the security card.

Further, a message exchange between the host and the security card is made many times until the host gives a try to the communication protocols that can be parsed and used by the security card, and when a common communication protocol does not exist, the communication ends in failure.

### SUMMARY OF THE INVENTION

The present invention provides a method and apparatus for determining a communication protocol in which one apparatus informs another apparatus of applicable communication protocols so as to determine a common communication protocol between the apparatuses, thereby reducing unnecessary parsing by using the determined common communication protocol.

The present invention also provides a method and apparatus for determining a communication protocol in which, when a commonly applicable communication protocol does not exist, a recommended communication protocol is automatically installed, and a communication can be made.

According to a first aspect of the present invention, there is provided an apparatus for determining a communication protocol, the apparatus including a protocol recording unit which records one or more applicable communication protocols, and a protocol parsing unit which parses a common communication protocol determined by another apparatus among the recorded communication protocols and provides the common communication protocol so as to communicate with the another apparatus.

According to a second aspect of the present invention, there is provided an apparatus for determining a communication protocol, the apparatus including a common protocol list creating unit which compares one or more communication protocols applicable by another apparatus and communication protocols applicable by the apparatus and creates a common communication protocol list, and a common protocol determining unit which determines a common communication protocol having a priority in the common communication protocol list and records the common communication protocol.

According to a third aspect of the present invention, there is provided an apparatus for determining a communication protocol, the apparatus including a protocol recording unit which confirms whether a common communication protocol exists in another apparatus and records information for a recommended communication protocol when the common communication protocol does not exist in the another apparatus, and a protocol installing unit which installs the recommended communication protocol in the another apparatus when the another apparatus allows the recommended communication protocol to be installed.

According to a fourth aspect of the present invention, there is provided an apparatus for determining a communication protocol, the apparatus including a protocol determining unit which determines whether or not to install a recommended communication protocol by referring to recorded recommended communication protocol information when a common communication protocol does not exist, and a protocol informing unit which transmits a result of the determination to another apparatus and allows the apparatus to communicate with the another apparatus using the recommended communication protocol when the another apparatus allows the recommended communication protocol to be installed.

According to a fifth aspect of the present invention, there is provided a method of determining a communication protocol in a first apparatus, the method including recording one or more applicable communication protocols, and parsing a common communication protocol determined by a second apparatus among the recorded communication protocols and providing the common communication protocol so as to communicate with the second apparatus.

According to a sixth aspect of the present invention, there is provided a method of determining a communication protocol in a first apparatus, the method including comparing one or more communication protocols applicable by a second apparatus and communication protocols applicable by the first apparatus and creating a common communication protocol list, and determining a common communication protocol having a priority in the common communication protocol list, and recording the common communication protocol.

According to a seventh aspect of the present invention, there is provided a method of determining a communication protocol in a first apparatus, the method including confirming whether a common communication protocol exists in a second apparatus and recording information for a recommended communication protocol when the common communication protocol does not exist in the second apparatus, and installing the recommended communication protocol in the second apparatus when the second apparatus allows the recommended communication protocol to be installed.

According to an eighth aspect of the present invention, there is provided a method of determining a communication protocol in a first apparatus, the apparatus including determining whether or not to install a recommended communication protocol by referring to recorded recommended communication protocol information when a common communication protocol does not exist, and transmitting a result of the determination to a second apparatus and allowing the first apparatus to communicate with the second apparatus using the recommended communication protocol when the second apparatus allows the recommended communication protocol to be installed.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a structure of a host and a security card according to a related art;

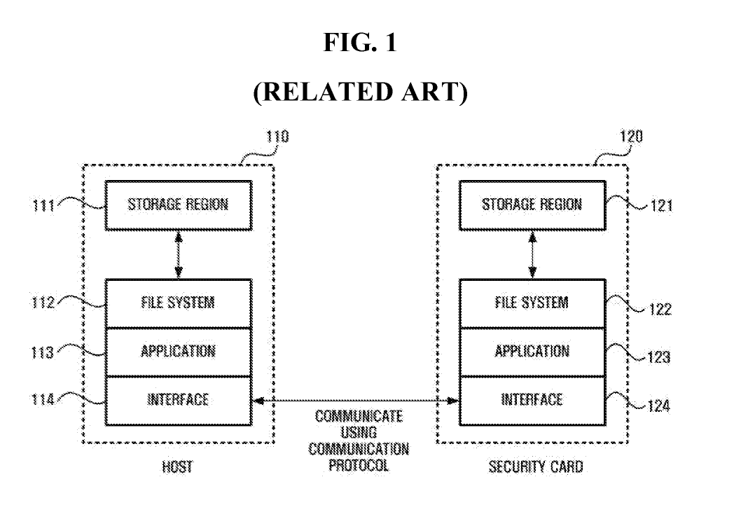

FIG. 2 is a flowchart illustrating a communication method of the host and the security card illustrated in FIG. 1;

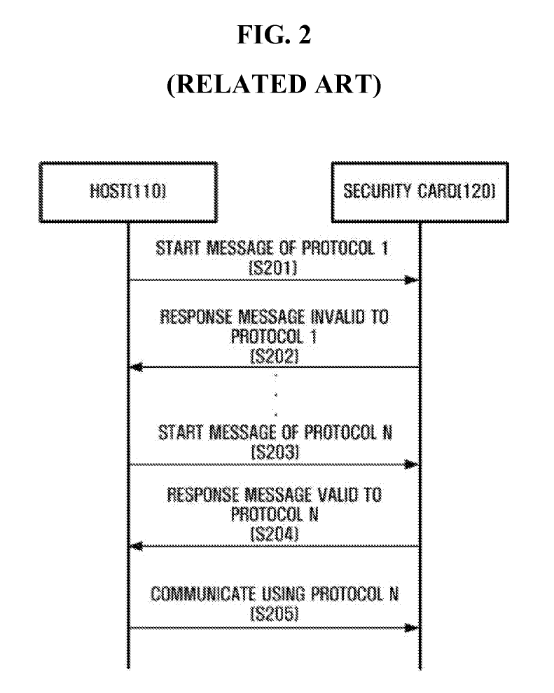

FIG. 3 is a block diagram illustrating a structure of an apparatus for determining a communication protocol according to an exemplary embodiment of the present invention;

FIG. 4 is a block diagram illustrating a structure of an apparatus for determining a communication protocol according to another exemplary embodiment of the present invention;

FIGS. 5 and 6 are block diagrams illustrating a structure of an apparatus for determining a communication protocol according to another exemplary embodiment of the present invention;

FIG. 7 is a diagram illustrating a sequential flow in which a host and a security card determine a common communication protocol and communicate with each other in accordance with an exemplary embodiment of the present invention;

FIG. 8 is a diagram illustrating a sequential flow in which a host and a security card determine a common communication protocol and communicate with each other in accordance with another exemplary embodiment of the present invention;

FIGS. 9 and 10 are diagrams illustrating a sequential flow in which a host and a security card determine a common communication protocol and communicate with each other in accordance with another exemplary embodiment of the present invention;

FIG. 11 is a diagram illustrating a sequential flow in which a host and a security card determine a common communication protocol, and a server installs a recommended communication protocol in the host to perform a communication in accordance with another exemplary embodiment of the present invention;

FIG. 12 is a diagram illustrating a sequential flow in which a host and a security card determine a common communication protocol, and a server installs a recommended communication protocol in the security card to perform a communication in accordance with another exemplary embodiment of the present invention; and

FIG. 13 is a diagram illustrating a sequential flow in which a server installs a common communication protocol in a host and a security card to perform a communication in accordance with another exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings.

The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims.

Like identification codes refer to like elements throughout the specification.

The present invention will be described hereinafter with reference to block diagrams or flowchart illustrations of a method and an apparatus for determining a communication protocol according to an exemplary embodiment thereof.

It is to be understood that blocks in the accompanying block diagrams and compositions of steps in flowcharts can be performed by computer program instructions.

These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flowcharts.

The computer program instructions can be stored in a computer available memory or a computer readable recording medium of the computer or the programmable data processing apparatus in order to realize the functions in a specific manner. Therefore, the instructions stored in the computer available memory or the computer readable recording medium can manufacture products including the instruction means for performing the functions described in the blocks in the block diagrams or the steps in the flowcharts.

Also, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flowcharts.

Each block or each step may indicate a portion of a module, a segment or a code including one or more executable instructions for performing a specific logical function (or functions).

It should be noted that, in some modifications of the present invention, the functions described in the blocks or the steps may be generated out of order.

For example, two blocks or steps continuously shown can be actually performed at the same time, or they can be performed sometimes in reverse order according to the corresponding functions.

The exemplary embodiments of the present invention will now be described more fully with reference to the accompanying drawings, in which exemplary embodiments of the present invention are shown.

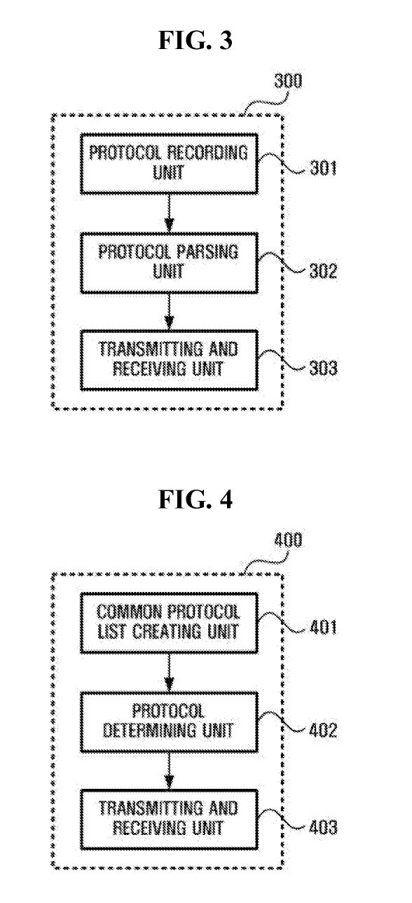

FIG. 3 is a block diagram illustrating a structure of an apparatus for determining a communication protocol according to an exemplary embodiment of the present invention.

Referring to FIG. 3, an apparatus 300 for determining a communication protocol includes a protocol recording unit 301 that records one or more applicable communication protocols, a protocol parsing unit 302 that parses a common communication protocol determined by a second apparatus among the recorded communication protocols and provides the common communication protocol so as to communicate with the second apparatus, and a transmitting and receiving unit 303 that communicates with the second apparatus using the common communication protocol.

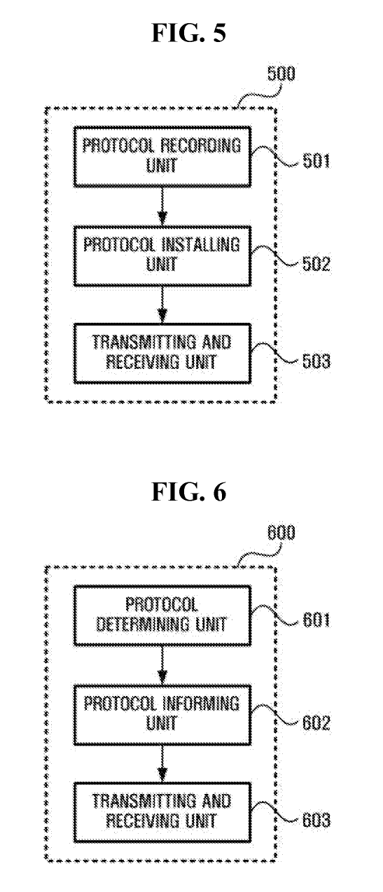

FIG. 4 is a block diagram illustrating a structure of an apparatus for determining a communication protocol according to another exemplary embodiment of the present invention.

Referring to FIG. 4, an apparatus 400 for determining a communication protocol includes a common protocol list creating unit 401 that compares one or more communication protocols applicable by a second apparatus and communication protocols applicable by the self apparatus and creates a common communication protocol list, a protocol determining unit 402 that determines a common communication protocol having a priority in the created common communication protocol list and records the determined common communication protocol, and a transmitting and receiving unit 403 that communicates with the second apparatus using the common communication protocol.

The term “unit” shown in FIGS. 3 to 6, that is, “module” or “table” means software, or a hardware component such as a Field Programmable Gate Array (FPGA) or an Application Specific Integrated Circuit (ASIC) and the modules each perform assigned functions.

However, the modules are not limited to software or hardware. The modules may be configured in an addressable storage medium, or may be configured to run on at least one processor.

Therefore, as an example, the modules include: components such as software components, object-oriented software components, class components, and task components; processors, functions, attributes, procedures, sub-routines, segments of program codes, drivers, firmware, microcodes, circuits, data, databases, data structures, tables, arrays, and variables.

The functions provided by the components and the modules may be combined into fewer components and or modules may be separated into additional components and modules.

For reference, the apparatus 300 shown in FIG. 3 may be included in a host and the apparatus 400 shown in FIG. 4 may be included in a security card. In contrast, the apparatus 400 shown in FIG. 4 may be included in the host, and the apparatus 300 shown in FIG. 3 may be included in the security card and determine a communication protocol.

At this time, the host may be a second apparatus in terms of the security card, and the security card may be the second apparatus in terms of the host.

First, the description is given of the case where the apparatus 300 shown in FIG. 3 is included in the host and the apparatus 400 shown in FIG. 4 is included in the security card, that is, the case where the security card determines the common communication protocol. At this time, it is assumed that the common communication protocol exists in the host and the security card.

The protocol recording unit 301 of the host records one or more communication protocols applicable by the host in a storage place (not shown) of the security card.

The common protocol list creating unit 401 of the security card compares the one or more communication protocols, which are recorded in the storage place of the security card and are applicable by the host, and communication protocols applicable by the security card, and creates a common communication protocol list.

The protocol determining unit 402 of the security card determines a common communication protocol having a priority in the common communication protocol list created by the common protocol list creating unit 401, and records the determined common communication protocol in the storage place of the security card.

The protocol parsing unit 302 of the host loads and parses the common communication protocol that is recorded in the storage place of the security card through the protocol determining unit 402 of the security card, and provides the parsed common communication protocol to the transmitting and receiving unit 303 so as to communicate with the transmitting and receiving unit 403 of the security card.

Second, the description is given of the case where the apparatus 300 shown in FIG. 3 is included in the security card and the apparatus 400 shown in FIG. 4 is included in the host, that is, the case where the host determines the common communication protocol. At this time, it is assumed that the common communication protocol exists in the host and the security card.

The protocol recording unit 301 of the security card records one or more communication protocols applicable by the security card in a storage place (not shown) of the security card.

For reference, when the protocol recording unit 301 is included in the host, the protocol recording unit 301 records one or more applicable protocols in the storage place of the security card, i.e. the second apparatus. Even when the protocol recording unit 301 is included in the security card, the protocol recording unit 301 records one or more applicable protocols in the storage place of the security card.

That is, according to the exemplary embodiment of the present invention, the storage place of the security card is used as an information exchange unit between the host and the security card, which provides a unit negotiating a communication protocol to be used in a security communication.

The common protocol list creating unit 401 of the host compares the one or more communication protocols, which are recorded in the storage place of the security card and are applicable by the security card, and communication protocols applicable by the host, and creates a common communication protocol list.

The protocol determining unit 402 of the host determines a common communication protocol having a priority in the common communication protocol list created by the common protocol list creating unit 401, and records the determined common communication protocol in the storage place of the security card.

For reference, when the protocol determining unit 402 is included in the host, the protocol determining unit 402 records the determined common communication protocol in the storage place of the security card, i.e. the second apparatus. Even when the protocol determining unit 402 is included in the security card, the protocol determining unit 402 records the determined common communication protocol in the storage place of the security card, and uses the storage place of the security card as an information exchange unit between the host and the security card, as described above regarding the protocol recording unit 301.

The protocol parsing unit 302 of the security card loads and parses the common communication protocol that is recorded in the storage place of the security card through the protocol determining unit 402 of the host, and provides the parsed common communication protocol to the transmitting and receiving unit 303 so as to communicate with the transmitting and receiving unit 403 of the host.

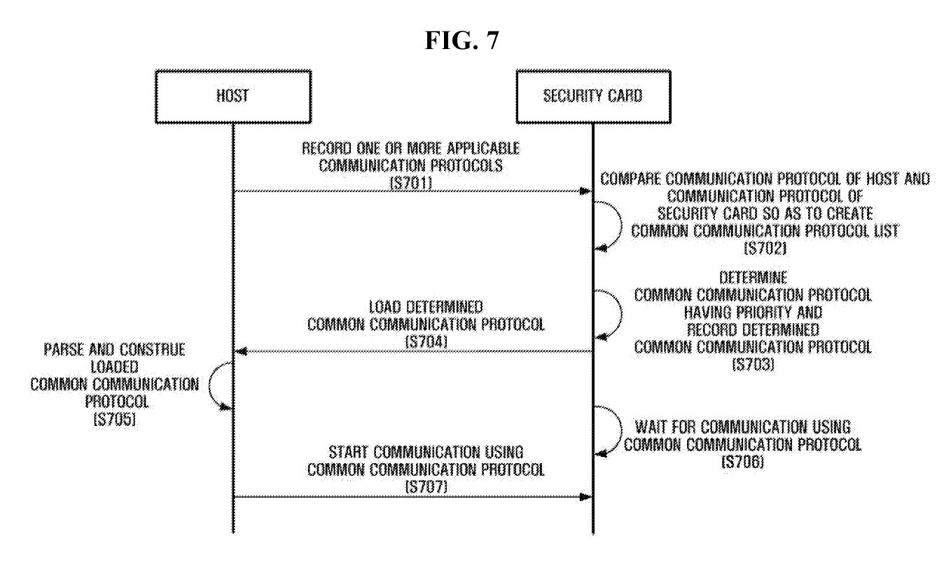

FIG. 5 is a block diagram illustrating a structure of an apparatus for determining a communication protocol according to another exemplary embodiment of the present invention.

Referring to FIG. 5, an apparatus 500 for determining a communication protocol includes a protocol recording unit 501 that confirms whether a common communication protocol exists in a second apparatus, and records information for a recommended communication protocol when the common communication protocol does not exist in the second apparatus, a protocol installing unit 502 that installs the recommended communication protocol in the second apparatus when the second apparatus allows the recommended communication protocol to be installed, and a transmitting and receiving unit 503 that communicates with the second apparatus using the recommended communication protocol.

FIG. 6 is a block diagram illustrating a structure of an apparatus for determining a communication protocol according to another exemplary embodiment of the present invention.

Referring to FIG. 6, an apparatus 600 for determining a communication protocol includes a protocol determining unit 601 that determines whether or not to install a recommended communication protocol by referring to recorded recommended communication protocol information, when a common communication protocol does not exist, a protocol informing unit 602 that transmits the determination on whether to or not install the recommended communication protocol to a second apparatus, and allows the apparatus 600 to communicate with the second apparatus using the recommended communication protocol, when the second apparatus allows the recommended communication protocol to be installed, and a transmitting and receiving unit 603 that communicates with the second apparatus using the recommended communication protocol.

For reference, the apparatus 500 shown in FIG. 5 may be included in the host and the apparatus 600 shown in FIG. 6 may be included in the security card. In contrast, the apparatus 600 shown in FIG. 6 may be included in the host, and the apparatus 500 shown in FIG. 5 may be included in the security card.

At this time, the host may be a second apparatus in terms of the security card, and the security card may be the second apparatus in terms of the host.

First, the description is given of the case where the apparatus 500 shown in FIG. 5 is included in the security card and the apparatus 600 shown in FIG. 6 is included in the host, that is, the case where the security card installs the recommended communication protocol in the host. At this time, it is assumed that the common communication protocol does not exist in the host and the security card.

Since the common communication protocol does not exist, the protocol recording unit 501 of the security card records, in a storage place (not shown) of the security card, information indicating that the common communication protocol does not exist and information for the recommended communication protocol of the security card.

In this case, the information for the recommended communication protocol includes information for a basis, on which the host and the security card determines the priority order of the protocol, such as an operating system (OS) applying the protocol or a minimal system specification, in addition to an identifier and a size of the protocol.

The protocol determining unit 601 of the host loads the information that is recorded in the storage place of the security card by the protocol recording unit 501 of the security card, confirms that the common communication protocol does not exist, and determines whether or not to install the recommended communication protocol by referring to the information for the recommended communication protocol.

The protocol informing unit 602 of the host transmits the determination on whether or not to install the recommended communication protocol having been determined by the protocol determining unit 601 to the security card through the transmitting and receiving unit 603, and the protocol installing unit 502 of the security card receives the determination on whether or not to install the recommended communication protocol having been transmitted by the protocol informing unit 602 of the host through the transmitting and receiving unit 503.

As the result of reception, when the host allows the recommended communication protocol of the security card to be installed, the protocol installing unit 502 of the security card installs the recommended communication protocol in the host.

When the recommended communication protocol is completely installed in the host, the protocol informing unit 602 of the host informs the security card that the recommended communication protocol is completely installed, through the transmitting and receiving unit 603. The security card waits for a communication with the host using the recommended communication protocol, and the host starts the communication with the security card using the recommended communication protocol.

Second, the description is given of the case where the apparatus 500 shown in FIG. 5 is included in the host and the apparatus 600 shown in FIG. 6 is included in the security card, that is, the case where the host installs the recommended communication protocol in the security card. At this time, it is assumed that the common communication protocol does not exist in the host and the security card.

The protocol recording unit 501 of the host records information for the recommended communication protocol in a storage place (not shown) of the security card.

In this case, the information for the recommended communication protocol includes information for a basis, on which the host and the security card determines the priority order of the protocol, such as an OS applying the protocol or a minimal system specification, in addition to an identifier and a size of the protocol.

For reference, when the protocol recording unit 501 is included in the host, the protocol recording unit 501 records the applicable recommended communication protocol in the storage place of the security card, i.e. second apparatus. Even when the protocol recording unit 501 is included in the security card, the protocol recording unit 501 records the applicable recommended communication protocol in the storage place of the security card.

That is, according to the exemplary embodiment of the present invention, the storage place of the security card is used as an information exchange unit between the host and the security card, which provides a unit negotiating a communication protocol to be used in a security communication.

The protocol determining unit 601 of the security card loads the information for the recommended communication protocol that is recorded in the storage place of the security card by the protocol recording unit 501 of the host, and determines whether or not to install the recommended communication protocol by referring to the information for the recommended communication protocol.

The protocol informing unit 602 of the security card transmits the determination on whether or not to install the recommended communication protocol having been determined by the protocol determining unit 601 to the host through the transmitting and receiving unit 603, and the protocol installing unit 502 of the host receives the determination on whether or not to install the recommended communication protocol having been transmitted by the protocol informing unit 602 of the security card through the transmitting and receiving unit 503.

As the result of reception, when the security card allows the recommended communication protocol of the host to be installed, the protocol installing unit 502 of the host installs the recommended communication protocol in the security card.

When the recommended communication protocol is completely installed in the security card, the protocol informing unit 602 of the security card informs the host that the recommended communication protocol is completely installed, through the transmitting and receiving unit 603. The security card waits for a communication with the host using the recommended communication protocol, and the host starts the communication with the security card using the recommended communication protocol.

For reference, when the common communication protocol does not exist in the host and the security card, the recommended communication protocol may be installed in either the host or the security card through an apparatus, such as an external server, or the recommended communication protocol may be installed in both the host and the security card.

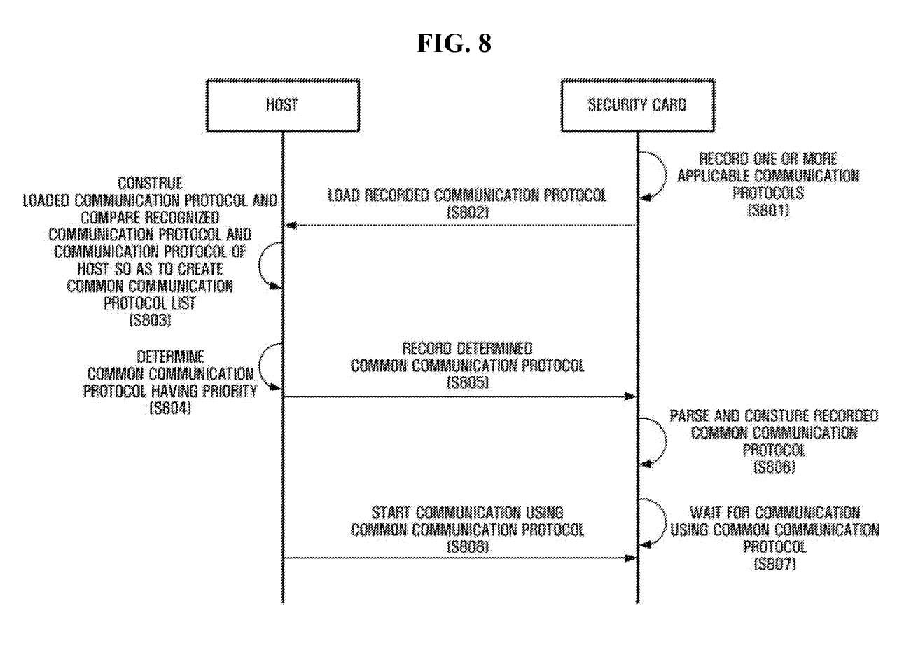

FIG. 7 is a diagram illustrating a sequential flow in which a host and a security card determine a common communication protocol and communicate with each other in accordance with an exemplary embodiment of the present invention.

For reference, the description is given of the case where the apparatus 300 shown in FIG. 3 is included in the host and the apparatus 400 shown in FIG. 4 is included in the security card, that is, the case where the security card determines the common communication protocol.

At this time, it is assumed that the common communication protocol exists in the host and the security card.

The protocol recording unit 301 of the host records one or more communication protocols applicable by the host in a storage place (not shown) of the security card (S701).

After Operation S701, the common protocol list creating unit 401 of the security card loads and construes the one or more communication protocols, which are recorded in the storage place of the security card and are applicable by the host, compares the construed communication protocols and communication protocols applicable by the security card, and creates a common communication protocol list (S702).

After Operation S702, the protocol determining unit 402 of the security card determines a common communication protocol having a priority in the common communication protocol list created by the common protocol list creating unit 401, and records the determined common communication protocol in the storage place of the security card (S703).

The protocol parsing unit 302 of the host loads the recorded common communication protocol through the protocol determining unit 402 of the security card (S704).

After Operation S704, the protocol parsing unit 302 of the host parses and construes the loaded common communication protocol, and provides the construed common communication protocol to the transmitting and receiving unit 303 so as to communicate with the transmitting and receiving unit 403 of the security card (S705).

After Operation S705, the security card waits for a communication with the host using the common communication protocol (S706), and the host starts a communication with the security card using the common communication protocol (S707).

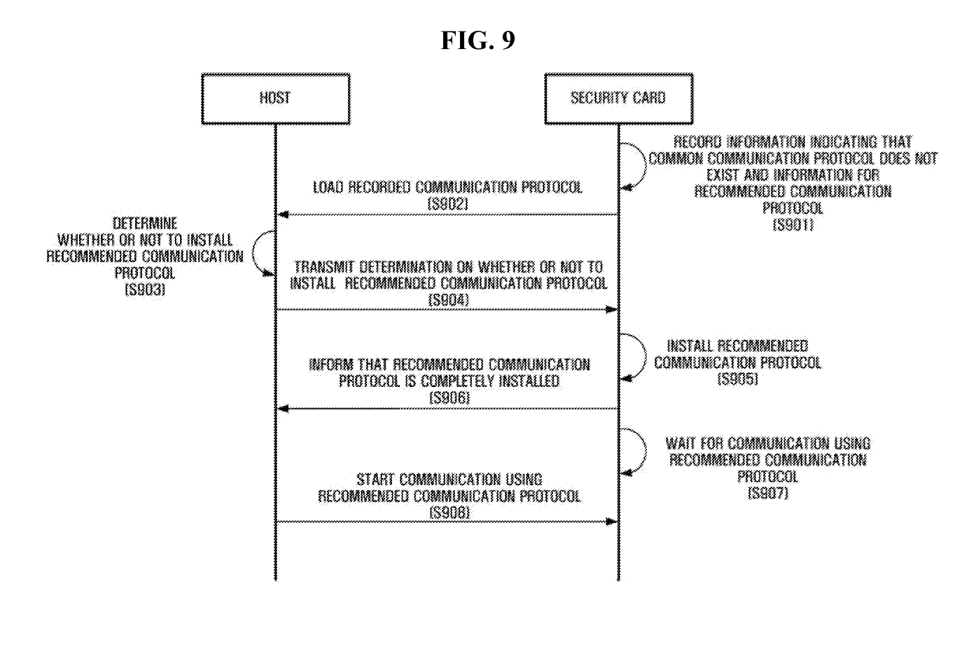

FIG. 8 is a diagram illustrating a sequential flow in which a host and a security card determines a common communication protocol and communicate with each other in accordance with another exemplary embodiment of the present invention.

For reference, FIG. 8 will be described by using the apparatuses shown in FIGS. 3 and 4, and the sequential flow shown in FIG. 8 corresponds to the case where the apparatus 300 shown in FIG. 3 is included in the security card and the apparatus 400 shown in FIG. 4 is included in the host, that is, the case where the host determines the common communication protocol.

At this time, it is assumed that the common communication protocol exists in the host and the security card.

The protocol recording unit 301 of the security card records one or more communication protocols applicable by the security card in a storage place (not shown) of the security card (S801).

After Operation S801, the common protocol list creating unit 401 of the host loads the one or more communication protocols, which are recorded in the storage place of the security card and are applicable by the security card (S802).

After Operation S802, the common protocol list creating unit 401 of the host construes the loaded communication protocols, compares the construed communication protocols and the communication protocols applicable by the host, and creates a common communication protocol list (S803).

After Operation S803, the protocol determining unit 402 of the host determines a common communication protocol having a priority in the common communication protocol list created by the common protocol list creating unit 401 (S804), and records the determined common communication protocol in the storage place of the security card (S805).

After Operation S805, the protocol parsing unit 302 of the security card construes and parses the common communication protocol that is recorded in the storage place of the security card through the protocol determining unit 402 of the host, and provides the parsed common communication protocol to the transmitting and receiving unit 303 so as to communicate with the transmitting and receiving unit 403 of the host (S806).

After Operation S806, the security card waits for a communication with the host using the common communication protocol (S807), and the host starts a communication with the security card using the common communication protocol (S808).

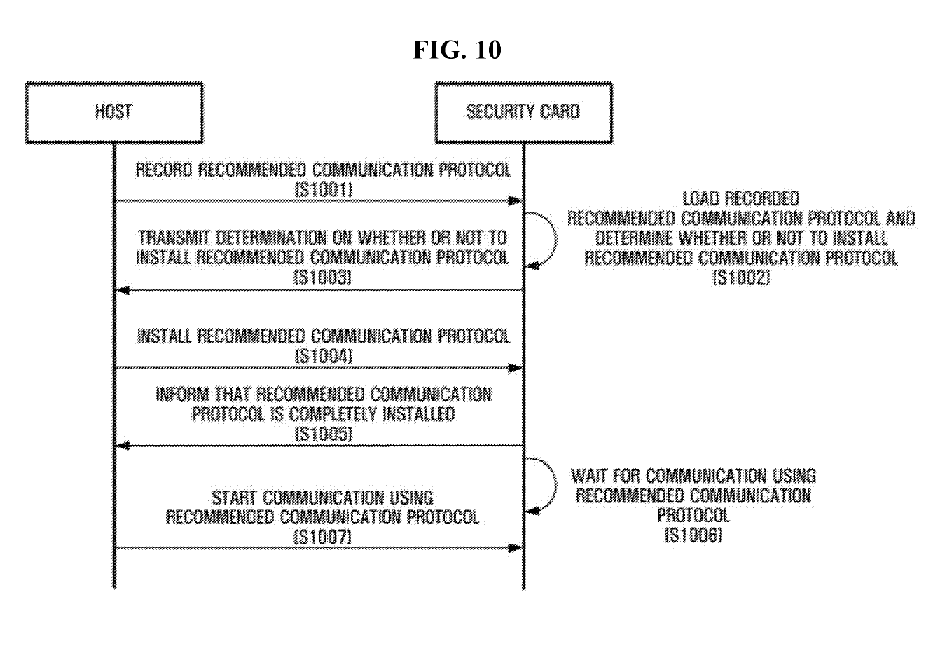

FIG. 9 is a diagram illustrating a sequential flow in which a host and a security card determines a common communication protocol and communicate with each other in accordance with another exemplary embodiment of the present invention.

For reference, FIG. 9 will be described by using the apparatuses shown in FIGS. 5 and 6, and the sequential flow shown in FIG. 9 corresponds to the case where the apparatus 500 shown in FIG. 5 is included in the security card and the apparatus 600 shown in FIG. 6 is included in the host, that is, the case where the security card installs the recommended communication protocol in the host.

At this time, it is assumed that the common communication protocol does not exist in the host and the security card.

Since the common communication protocol does not exist, the protocol recording unit 501 of the security card records, in a storage place (not shown) of the security card, information indicating that the common communication protocol does not exist and information for the recommended communication protocol of the security card (S901).

In this case, the information for the recommended communication protocol includes means information, such as a protocol code and a size of the protocol.

After Operation S901, the protocol determining unit 601 of the host loads the information that is recorded in the storage place of the security card by the protocol recording unit 501 of the security card (S902), confirms that the common communication protocol does not exist, and determines whether or not to install the recommended communication protocol by referring to the information for the recommended communication protocol (S903).

After Operation S903, the protocol informing unit 602 of the host transmits the determination on whether or not to install the recommended communication protocol having been determined by the protocol determining unit 601 to the security card through the transmitting and receiving unit 603 (S904).

After Operation S904, the protocol installing unit 502 of the security card receives the determination on whether or not to install the recommended communication protocol having been transmitted by the protocol informing unit 602 of the host through the transmitting and receiving unit 503.

As the result of reception, when the host allows the recommended communication protocol of the security card to be installed, the protocol installing unit 502 of the security card installs the recommended communication protocol in the host (S905).

When the recommended communication protocol is completely installed in the host, the protocol informing unit 602 of the host informs the security card that the recommended communication protocol is completely installed, through the transmitting and receiving unit 603 (S906). The security card waits for a communication with the host using the recommended communication protocol (S907), and the host starts the communication with the security card using the recommended communication protocol (S908).

FIG. 10 is a diagram illustrating a sequential flow in which a host and a security card determines a common communication protocol and communicate with each other in accordance with another exemplary embodiment of the present invention.

For reference, FIG. 10 will be described by using the apparatuses shown in FIGS. 5 and 6, and the sequential flow shown in FIG. 10 corresponds to the case where the apparatus 500 shown in FIG. 5 is included in the host and the apparatus 600 shown in FIG. 6 is included in the security card, that is, the case where the host installs the recommended communication protocol in the security card.

At this time, it is assumed that the common communication protocol does not exist in the host and the security card.

The protocol recording unit 501 of the host records the information for a recommended communication protocol in a storage place (not shown) of the security card (S1001).

In this case, the information for the recommended communication protocol means information, such as a protocol code and a size of the protocol.

After Operation S1001, the protocol determining unit 601 of the security card loads the information for the recommended communication protocol that is recorded in the storage place of the security card by the protocol recording unit 501 of the host, and determines whether or not to install the recommended communication protocol by referring to the information for the recommended communication protocol (S1002).

After Operation S1002, the protocol informing unit 602 of the security card transmits the determination on whether or not to install the recommended communication protocol having been determined by the protocol determining unit 601 to the host through the transmitting and receiving unit 603 (S1003).

After Operation S1003, the protocol installing unit 502 of the host receives the determination on whether or not to install the recommended communication protocol having been transmitted by the protocol informing unit 602 of the security card through the transmitting and receiving unit 503.

As the result of reception, when the security card allows the recommended communication protocol of the host to be installed, the protocol installing unit 502 of the host installs the recommended communication protocol in the security card (S1004).

When the recommended communication protocol is completely installed in the security card, the protocol informing unit 602 of the security card informs the host that the recommended communication protocol is completely installed, through the transmitting and receiving unit 603 (S1005). The security card waits for a communication with the host using the recommended communication protocol (S1006), and the host starts the communication with the security card using the recommended communication protocol (S1007).

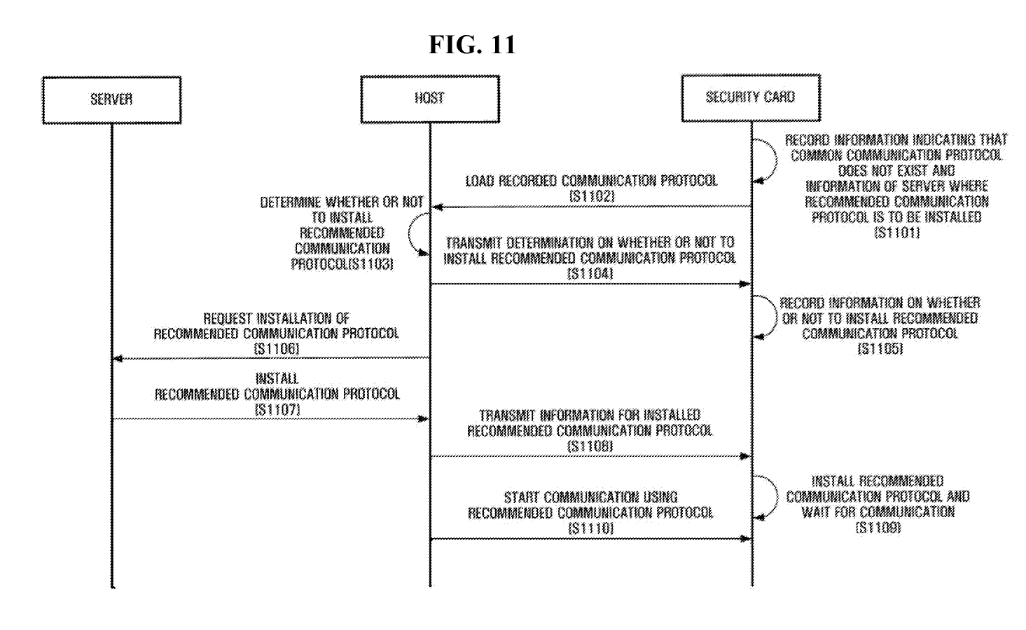

FIG. 11 is a diagram illustrating a sequential flow in which a host and a security card determine a common communication protocol and a server installs a recommended communication protocol in the host so as to perform a communication in accordance with another exemplary embodiment of the present invention.

For reference, FIG. 11 will be described by using the apparatuses shown in FIGS. 5 and 6, and the sequential flow shown in FIG. 11 corresponds to the case where the apparatus 500 shown in FIG. 5 is included in the security card and the apparatus 600 shown in FIG. 6 is included in the host, that is, the case where the security card installs the recommended communication protocol in the host.

At this time, it is assumed that the common communication protocol does not exist in the host and the security card.

Since the common communication protocol does not exist, the protocol recording unit 501 of the security card records, in a storage place (not shown) of the security card, information indicating that the common communication protocol does not exist and information for a server where the recommended communication protocol is to be installed (S1101).

In this case, the information for the server where the recommended communication protocol is to be installed includes at least one of an Internet Protocol (IP) and an Uniform Resource Locator (URL) of the corresponding server where the recommended communication protocol can be installed.

After Operation S1101, the protocol determining unit 601 of the host loads the information that is recorded in the storage place of the security card by the protocol recording unit 501 of the security card (S1102), confirms that the common communication protocol does not exist, construes the information for the recommended communication protocol, and determines whether or not to install the recommended communication protocol (S1103).

After Operation S1103, the protocol informing unit 602 of the host transmits the determination on whether or not to install the recommended communication protocol having been determined by the protocol determining unit 601 to the security card through the transmitting and receiving unit 603 (S1104).

After Operation S1104, the protocol installing unit 502 of the security card receives the determination on whether or not to install the recommended communication protocol having been transmitted by the protocol informing unit 602 of the host through the transmitting and receiving unit 503.

As the result of reception, when the host allows the recommended communication protocol of the security card to be installed, the protocol installing unit 502 of the security card transmits the information on whether or not to install the recommended communication protocol to the protocol recording unit 501, and the protocol recording unit 501 records the information on whether to or not install the recommended communication protocol in the storage place of the security card (S1105).

After Operation S1105, the host accesses the server where the recommended communication protocol is to be installed by using the information for the sever, such as the IP or the URL loaded by the protocol determining unit 601 of the host in Operation S1102, and requests to install the recommended communication protocol (S1106).

After Operation S1106, the server installs the recommended communication protocol in the host (S1107), and the host where the recommended communication protocol is installed transmits the information for the recommended communication protocol to the security card (S1108).

After Operation S1108, the protocol installing unit 502 of the security card installs the received recommended communication protocol, the security card waits for a communication with the host using the recommended communication protocol (S1109), and the host starts a communication with the security card using the recommended communication protocol (S1110).

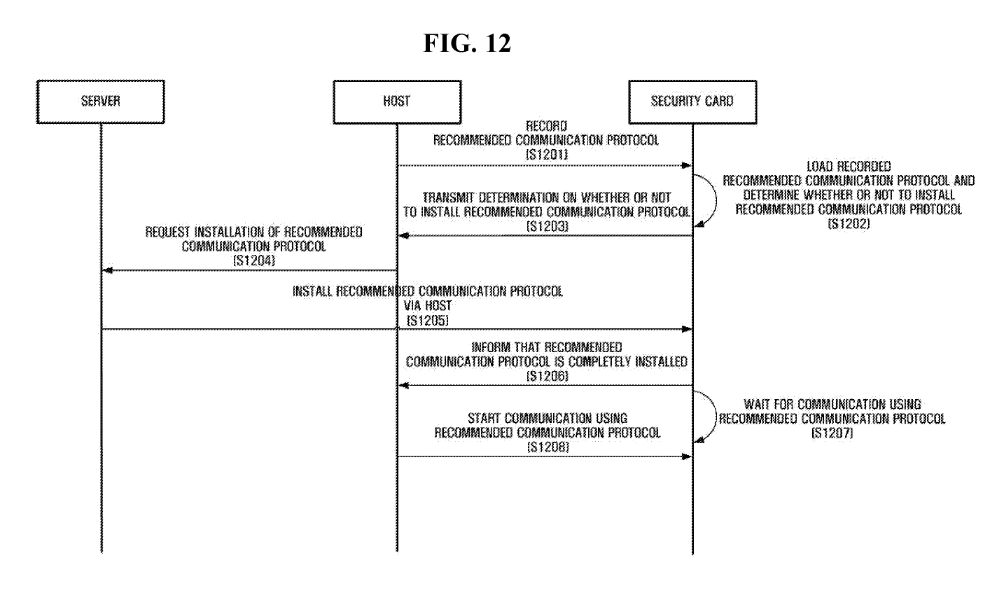

FIG. 12 is a diagram illustrating a sequential flow in which a host and a security card determines a common communication protocol and a server installs a recommended communication protocol in a security card so as to perform a communication in accordance with another exemplary embodiment of the present invention.

For reference, FIG. 12 will be described by using the apparatuses shown in FIGS. 5 and 6, and the sequential flow shown in FIG. 12 corresponds to the case where the apparatus 500 shown in FIG. 5 is included in the host and the apparatus 600 shown in FIG. 6 is included in the security card, that is, the case where the host installs the recommended communication protocol in the security card.

At this time, it is assumed that the common communication protocol does not exist in the host and the security card.

The protocol recording unit 501 of the host records the information for the recommended communication protocol in the storage place (not shown) of the security card (S1201).

In this case, the information for the recommended communication protocol includes means information, such as a protocol code and a size of the protocol.

After Operation S1201, the protocol determining unit 601 of the security card loads and construes the information for the recommended communication protocol that is recorded in the storage place of the security card by the protocol recording unit 501 of the host, and determines whether or not to install the recommended communication protocol (S1202).

After Operation S1202, the protocol informing unit 602 of the security card transmits the determination on whether or not to install the recommended communication protocol having been determined by the protocol determining unit 601 to the host through the transmitting and receiving unit 603 (S1203).

After Operation S1203, the protocol installing unit 502 of the host receives the determination on whether or not to install the recommended communication protocol having been transmitted by the protocol informing unit 602 of the security card through the transmitting and receiving unit 503.

As the result of reception, when the security card allows the recommended communication protocol of the host to be installed, the host requests the server to install the recommended communication protocol in the security card (S1204).

After Operation S1204, the server installs the recommended communication protocol in the security card via the host (S1205).

After Operation S1205, the protocol informing unit 602 of the security card informs the host that the recommended communication protocol is completely installed, through the transmitting and receiving unit 603 (S1206). The security card waits for a communication with the host using the recommended communication protocol (S1207), and the host starts the communication with the security card using the recommended communication protocol (S1208).

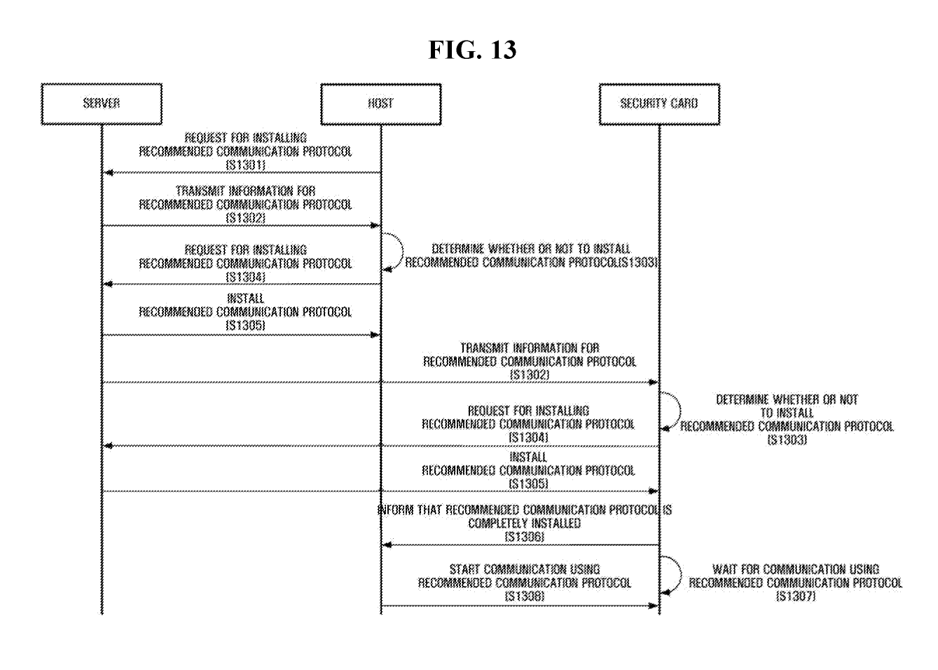

FIG. 13 is a diagram illustrating a sequential flow in which a server installs a common communication protocol in a host and a security card so as to perform a communication in accordance with another exemplary embodiment of the present invention.

At this time, it is assumed that the common communication protocol does not exist in the host and the security card.

The host requests the server to install a recommended communication protocol (S1301).

After Operation S1301, the server transmits information for the recommended communication protocol to the host and the security card (S1302).

After Operation S1302, the host and the security card determine whether or not to install the recommended communication protocol (S1303), and when it is determined that the recommended communication protocol is to be installed, the host and the security card request the server to install the recommended communication protocol in the host and the security card (S1304).

After Operation S1304, the server installs the recommended communication protocol in the host and the security card (S1305).

After Operation S1305, when the recommended communication protocol is completely installed, the security card informs the host that the recommended communication protocol is completely installed (S1306).

After Operation S1306, the security card waits for a communication with the host using the installed recommended communication protocol (S1307), and the host starts a communication with the security card using the recommended communication protocol (S1308).

Although the present invention has been described in connection with the exemplary embodiments of the present invention, it will be apparent to those skilled in the art that various modifications and changes may be made thereto without departing from the scope and spirit of the present invention. Therefore, it should be understood that the above exemplary embodiments are not limitative, but illustrative in all aspects.

The method and apparatus for determining a communication protocol according to the exemplary embodiments of the present inventions can achieve the following effects.

One apparatus informs another apparatus of applicable communication protocols so as to determine a common communication protocol between the apparatuses, thereby reducing unnecessary parsing and a time delay by using the determined common communication protocol.

Further, when a commonly applicable communication protocol does not exist, a recommended communication protocol is automatically installed, and a communication can be made.

Furthermore, a storage place of a security card is used as an information exchange unit between a host and the security card, which provides a unit negotiating a communication protocol to be used in a security communication.

What is claimed is:

1. An apparatus for determining a communication protocol, the apparatus comprising:
a protocol recording unit which records one or more applicable communication protocols; and
a protocol parsing unit which parses a common communication protocol determined by another apparatus among the recorded communication protocols, and provides the common communication protocol so as to communicate with the another apparatus.

2. The apparatus of claim 1, wherein the protocol recording unit records the one or more communication protocols in any one of a storage place of the apparatus and a storage place of the another apparatus.

3. The apparatus of claim 1, further comprising:
a transmitting and receiving unit which communicates with the another apparatus using the common communication protocol.

4. An apparatus for determining a communication protocol, the apparatus comprising:
a common protocol list creating unit which compares one or more communication protocols applicable by another apparatus and communication protocols applicable by the apparatus, and creates a common communication protocol list; and
a protocol determining unit which determines a common communication protocol having a priority in the common communication protocol list, and records the common communication protocol.

5. The apparatus of claim 4, wherein the protocol determining unit records the common communication protocol in any one of a storage place of the apparatus and a storage place of the another apparatus.

6. The apparatus of claim 4, further comprising:
a transmitting and receiving unit which communicates with the another apparatus using the common communication protocol.

7. An apparatus for determining a communication protocol, the apparatus comprising:
a protocol recording unit which confirms whether a common communication protocol exists in another apparatus, and records information for a recommended communication protocol when the common communication protocol does not exist in the another apparatus; and
a protocol installing unit which installs the recommended communication protocol in the another apparatus, when the another apparatus allows the recommended communication protocol to be installed.

8. The apparatus of claim 7, wherein the protocol recording unit records the information for the recommended communication protocol in any one of a storage place of the apparatus and a storage place of the another apparatus.

9. The apparatus of claim 7, further comprising:
a transmitting and receiving unit which communicates with the another apparatus using the recommended communication protocol.

10. An apparatus for determining a communication protocol, the apparatus comprising:
a protocol determining unit which determines whether or not to install a recommended communication protocol by referring to recorded recommended communication protocol information, when a common communication protocol does not exist; and
a protocol informing unit which transmits a result of the determination to another apparatus, and allows the apparatus to communicate with the another apparatus using the recommended communication protocol when the another apparatus allows the recommended communication protocol to be installed.

11. The apparatus of claim 10, wherein the protocol determining unit refers to the recommended communication protocol information recorded in any one of a storage place of the apparatus and a storage place of the another apparatus.

12. The apparatus of claim 10, further comprising:
a transmitting and receiving unit which communicates with the another apparatus using the recommended communication protocol.

13. A method of determining a communication protocol in a first apparatus, the method comprising:
recording one or more applicable communication protocols; and
parsing a common communication protocol determined by a second apparatus among the recorded communication protocols, and providing the common communication protocol so as to communicate with the second apparatus.

14. The method of claim 13, wherein the one or more communication protocols are recorded in any one of a storage place of the first apparatus and a storage place of the second apparatus.

15. The method of claim 13, further comprising:
communicating with the second apparatus using the common communication protocol.

16. A method of determining a communication protocol in a first apparatus, the method comprising:
comparing one or more communication protocols applicable by a second apparatus and communication protocols applicable by the first apparatus, and creating a common communication protocol list; and
determining a common communication protocol having a priority in the common communication protocol list, and recording the common communication protocol.

17. The method of claim 16, wherein the common communication protocol is recorded in any one of a storage place of the first apparatus and a storage place of the second apparatus.

18. The method of claim 16, further comprising:
communicating with the second apparatus using the common communication protocol.

19. A method of determining a communication protocol in a first apparatus, the method comprising:
confirming whether a common communication protocol exists in a second apparatus, and recording information for a recommended communication protocol when the common communication protocol does not exist in the second apparatus; and
installing the recommended communication protocol in the second apparatus, when the second apparatus allows the recommended communication protocol to be installed.

20. The method of claim 19, wherein the information for the recommended communication protocol is recorded in any one of a storage place of the first apparatus and a storage place of the second apparatus.

21. The method of claim 19, further comprising:
communicating with the second apparatus using the recommended communication protocol.

22. A method of determining a communication protocol in a first apparatus, the apparatus comprising:
determining whether or not to install a recommended communication protocol by referring to recorded recommended communication protocol information, when a common communication protocol does not exist; and
transmitting a result of the determination to a second apparatus, and allowing the first apparatus to communicate with the second apparatus using the recommended communication protocol when the second apparatus allows the recommended communication protocol to be installed.

23. The method of claim 22, wherein the determining of whether or not to install the recommended communication protocol comprises referring to the recommended communication protocol information recorded in any one of a storage place of the first apparatus and a storage place of the second apparatus.

24. The method of claim 22, further comprising:
communicating with the second apparatus using the recommended communication protocol.

25. A computer readable recording medium storing a computer program for performing a method of determining a communication protocol in a first apparatus, the method comprising:
recording one or more applicable communication protocols; and
parsing a common communication protocol determined by a second apparatus among the recorded communication protocols and providing the common communication protocol so as to communicate with the second apparatus.

26. A computer readable recording medium storing a computer program for performing a method of determining a communication protocol in a first apparatus, the method comprising:
comparing one or more communication protocols applicable by a second apparatus and communication protocols applicable by the first apparatus, and creating a common communication protocol list; and
determining a common communication protocol having a priority in the common communication protocol list, and recording the common communication protocol.

27. A computer readable recording medium storing a computer program for performing a method of determining a communication protocol in a first apparatus, the method comprising:
confirming whether a common communication protocol exists in a second apparatus, and recording information for a recommended communication protocol when the common communication protocol does not exist in the second apparatus; and
installing the recommended communication protocol in the second apparatus, when the second apparatus allows the recommended communication protocol to be installed.

28. A computer readable recording medium storing a computer program for performing a method of determining a communication protocol in a first apparatus, the method comprising:
determining whether or not to install a recommended communication protocol by referring to recorded recommended communication protocol information, when a common communication protocol does not exist; and
transmitting a result of the determination to a second apparatus, and allowing the first apparatus to communicate with the second apparatus using the recommended communication protocol when the second apparatus allows the recommended communication protocol to be installed.
